(19) United States
(12) Patent Application Publication
(10) Pub. No.: US 2022/0369567 A1
(43) Pub. Date: Nov. 24, 2022

(54) MODULAR HORTICULTURAL LIGHTING SYSTEM

(71) Applicant: Fluence Bioengineering, Inc., Austin, TX (US)

(72) Inventors: John Smolik, Austin, TX (US); Michael Fellabaum, Austin, TX (US); Marthinus Christoffel Van der Schyf, Austin, TX (US); Corinne Wilder, Austin, TX (US); Mitchell Galton, Austin, TX (US)

(73) Assignee: Fluence Bioengineering, Inc., Austin, TX (US)

(21) Appl. No.: 17/773,186

(22) PCT Filed: Nov. 6, 2020
(86) PCT No.: PCT/US20/59337

§ 371 Date: Apr. 29, 2022

Related U.S. Application Data
(60) Provisional application No. 62/935,366, filed on Nov. 14, 2019.
(60) Provisional application No. 63/011,336, filed on Apr. 17, 2020.
(60) Provisional application No. 63/066,347, filed on Aug. 17, 2020.

(51) Int. Cl. A01G 7/04; F21V 17/02

(52) U.S. Cl. CPC A01G 7/045; F21V 17/02

(57) ABSTRACT

Various implementations disclosed herein include a lighting system that includes a power supply and a lighting fixture coupled to the power supply, the lighting fixture comprising a determined number of removable emitting surfaces, wherein the lighting system satisfies a target PPFD at a canopy of a plant bed having a specified area and a specified mounting height of the determined number of emitting surfaces above the canopy, the determined number of emitting surfaces is determined based on at least the target PPFD, the specified area, and the specified mounting height, a system wattage supplied by the power supply is determined based on at least the determined number, the target PPFD, the specified area, and the specified mounting height, and a spacing between each of the emitting surfaces is determined based on at least the determined number and the specified mounting height.

### CROSS-REFERENCE TO RELATED APPLICATIONS

The present application is an international application and claims priority to U.S. Provisional Application No. 62/935,366, filed Nov. 14, 2019 and entitled “MODULAR HORTICULTURAL LIGHTING SYSTEM”; U.S. Provisional Application No. 63/011,336, filed Apr. 17, 2020 and entitled “MODULAR HORTICULTURAL LIGHTING SYSTEM”; and U.S. Provisional Application No. 63/066,347, filed Aug. 17, 2020 and entitled “MODULAR HORTICULTURAL LIGHTING SYSTEM”, each of which are hereby incorporated by reference in their entirety.

### FIELD OF THE DISCLOSURE

This disclosure relates to horticultural lighting systems, and specifically to systems and methods of adapting horticulture lighting systems to meet specific customer needs using modular parts.

### BACKGROUND

Horticultural lighting is an important part of indoor farming environments as they have a high impact on plant growth but also consume a lot of power. Growers always seek to reduce operational costs while improving crop quantity and quality. A lighting solution's cost is determined by its efficacy, wattage, and number of emitting surfaces (e.g., light bars). The higher the number of emitting surfaces and wattage, the greater the capital expenditure (CapEx). For a given geometry and a desired uniformity, a minimum number of emitting surfaces are necessary, but more emitting surfaces may be added as long as the total wattage remains the same.

When the geometry and photosynthetic photon flux (PPF) of the fixture are fixed and when given a light uniformity target, the average photosynthetic photon flux density (PPFD) of the system, which is a measure of irradiance of light on leaf, becomes uniquely fixed. Alternately, given a fixed geometry and an average PPFD target, the uniformity of the system becomes uniquely fixed. Therefore, any geometry, uniformity, or PPFD that strays from these unique circumstances is not optimal. As an example, a system containing 3 light bars spaced 8 inches apart is meant to be placed over an illuminated area that is 8 inches away to yield optimal uniformity. At a fixed wattage and a fixed efficacy, the PPFD is also fixed. If a higher PPFD level is desired, the wattage for the system must increase or light uniformity will suffer. Conversely, if a lower PPFD level is desired the wattage must decrease, or light uniformity will suffer.

Traditionally, lighting manufacturers have created lighting systems with a fixed number of emitting surfaces per driver, driven at a fixed wattage and efficacy. To function properly, lighting systems must include emitting surfaces and a power supply, but these components are usually predefined and cannot be added to or subtracted from. With a fixed lighting system, conventional thinking dictates that the lighting manufacturer must offer a unique SKU at varying wattages/efficacy in order to meet various lighting requirements. A workaround for this problem is to over-shoot the intensity requirement and then dim a fixed lighting system down to the appropriate level. While this may eliminate the SKU proliferation issue, the customer is likely forced to buy more system than is needed.

Thus fixed lighting systems almost always over-shoot or under-shoot target requirements. Modifying them to hit the targeted requirements is expensive. The result is an under-performing solution that doesn't quite meet the customer's PPFD/uniformity requirements, or an over-performing solution that meets the customer's requirements but is more costly than necessary. Customers may opt for a customized solution, but this option is only cost-effective at large scales and not viable for most customers.

From the seller's perspective, the only way to solve for all potential requirements is to alter the predefined system to balance both performance and price targets. Typically, the seller may customize the power output of the power supply, redesign the emission surfaces to achieve different preset intensities, or both. All options lead to more components to stock and manage, added costs associated with business operations and overhead, and constant rework of “standard” predefined lighting system that is rarely leveraged for more than a few customers. All of this leads to higher solution costs and higher prices for the customer. In addition, customization of standard products leads to delays in lighting designs, quote submissions, and ultimately order fulfillment, as well as the opportunity costs of constantly redesigning existing systems instead of dedicating engineering resources to other tasks. Customization also increases logistical complexity, which ultimately leads to higher overhead and, more importantly, quality issues that either take time to mitigate up front, or money to fix on the later. Thus what is needed is a cost-effective modular solution that can be easily configured to provide a wide range of performance characteristics.

### SUMMARY

The systems and method disclosed herein present an improved approach of designing lighting systems that allows the number of emitting surfaces to be varied at a given wattage/efficacy to hit a specific PPFD target and light uniformity level. This means that the wattage per emitting surface is flexible and allowed to change based on the application requirements. From an engineering and operations standpoint, the system is ultra-flexible while limiting the number of different parts (SKUs) to a manageable number.

From a customer standpoint, they are provided the least number of parts that meet their PPFD/uniformity requirements, thus increasing the overall system reliability and lowering their cost. Due to the modular nature of the solution, the customer can still add or remove emitting surfaces to or from the system to either extend the system over a smaller/larger geometry, or reconfigure the system to hit new PPFD/uniformity targets over the existing geometry.

From a sales standpoint, modularity of components and performance would greatly assist in quickly deriving the most optimal solution with minimal input from the customer. Currently, lighting designs are based off the fixture's pre-set output and wattage, and thus efficacy. This is the constraint imposed by a fixed system—the seller is forced to sell a lighting system with a fixed wattage, output and efficacy with a predetermined number of components. When systems fall outside of predetermined optimal configurations, the customer and the seller must negotiate compromises. As such, the lighting design process and sales process takes longer, and the customer must often settle for the closest fitting solution instead of the optimal solution. A modular lighting system allows customers to prioritize any lighting goal (whether related to uniformity, intensity, efficacy, cost, etc.) with a greater level of precision and at a minimum cost (e.g., best fit for least cost). Simultaneously, the flexibility of the system allows sales resources to arrive at the ideal solution faster and easier, thus allowing them to allocate time more efficiently and reduce the sales cycle time. The system components may be determined formulaically when the number of emitting surfaces is determined only by the geometry of the system. The required wattage is derived from the PPFD requirements of the system which, along with its geometry, are provided by the customer. An application may be used to calculate the optimal set of components to build the lighting system. These calculations are programmatically based on hard requirements from the customer and allow quick determination of an optimal solution.

In summary, the benefits of the modular system disclosed herein include flexibility in initial design and later modifications, optimization and minimization of the number of components used, dynamic redistribution of parameters (e.g., total wattage) among all components when emitting surfaces are added to or removed from the lighting system, quick design turn-around, ease in replacing failed components, and the ability to divert excess resources (e.g., wattage) for other uses.

Various implementations disclosed herein include a lighting system that includes a power supply and a lighting fixture coupled to the power supply, the lighting fixture including a determined number of removable emitting surfaces, wherein the lighting system satisfies a target photosynthetic photon flux density (PPFD) at a canopy of a plant bed having a specified area and a specified mounting height of the determined number of emitting surfaces above the canopy, the determined number of emitting surfaces is determined based on at least the target PPFD, the specified area, and the specified mounting height, a system wattage supplied by the power supply is determined based on at least the determined number, the target PPFD, the specified area, and the specified mounting height, and a spacing between each of the emitting surfaces is determined based on at least the determined number and the specified mounting height.

In some implementations, when at least one of the target PPFD, the specified area, and the specified mounting height are changed, the determined system wattage, the determined number, and the spacing between each of the emitting surfaces are re-determined. In some implementations, when the re-determined system wattage exceeds a maximum wattage of the power supply, the power supply is replaced by a replacement power supply having a maximum wattage above the re-determined system wattage. In some implementations, when the re-determined number of emitting surfaces is greater than the determined number of emitting surfaces, additional removable emitting surfaces are added to the lighting fixture and a spacing between each of the re-determined number of emitting surfaces is adjusted to equal to the re-determined spacing. In some implementations, when the re-determined number of emitting surfaces is less than the determined number of emitting surfaces, excess emitting surfaces are removed from the lighting fixture and a spacing between each of the remaining emitting surfaces is adjusted to equal to the re-determined spacing.

In some implementations, when the determined system wattage is less than a maximum wattage of the power supply, the system further includes one or more peripheral devices coupled to the power supply. In some implementations, the one or more peripheral devices includes at least one of a fan, a heater, a sensor, a communications module, and a control device. In some implementations, the one or more peripheral devices consume a total peripheral wattage, the total peripheral wattage plus the determined system wattage being less than or equal to the maximum wattage of the power supply.

In some implementations, the system further includes a first connector coupling the power supply to the determined number of emitting surfaces. In some implementations, the determined number changes to a re-determined number of emitting surfaces, the first connector is replaced by a second connector that couples the power supply to the re-determined number of emitting surfaces. In some implementations, the system further includes a plurality of connectors coupling the power supply to the determined number of emitting surfaces. In some implementations, when one of the plurality of connectors fails, the failed connector is replaced by an identical replacement connector. In some implementations, when at least one of the emitting surfaces fail the at least one failed emitting surfaces are removed, the spacing between the remaining emitting surfaces is adjusted based on the specified area, and the specified mounting height is adjusted based on the spacing between the remaining emitting surfaces. In some implementations, the specified mounting height is equal to the spacing between each of the emitting surfaces. In some implementations, the power supply is selected from a plurality of power supplies, each of the plurality of power supplies having a maximum wattage, and the selected power supply has a smallest difference between its maximum wattage and the system wattage. In some implementations, different combinations of values of the system wattage, the determined number, the spacing, and the specified mounting height satisfy the target PPFD and the specified area.

Further implementations disclosed herein include a method for determining characteristics for a lighting system. The method includes receiving a target photosynthetic photon flux density (PPFD) at a canopy of a plant bed having a specified area and a specified mounting height between the canopy and emitting surfaces of a lighting fixture above the plant bed, determining a number of removable emitting surfaces on the lighting fixture based on at least the target PPFD, the specified area, and the specified mounting height, determining a system wattage supplied by a power supply of the lighting system based on at least the determined number, the target PPFD, the specified area, and the specified mounting height, and determining a spacing between each of the emitting surfaces based on at least the determined number and the specified mounting height.

Further implementations disclosed herein include a lighting system that includes one or more power supplies and one or more lighting fixtures coupled to the one or more power supplies, each of the lighting fixtures including a number of removable emitting surfaces. A system wattage provided by the one or more power supplies, a number of emitting surfaces on each lighting fixture, and a spacing between the emitting surfaces on each lighting fixtures are determined based on a target photosynthetic photon flux density (PPFD) at a canopy of a plant bed having a specified area and a specified mounting height between the canopy and the emitting surfaces.

Further implementations disclosed herein include a lighting system that includes one or more power supplies, one or more lighting fixtures each having one or more emitting surfaces, and one or more connectors coupling the one or more power supplies with the one or more lighting fixtures, in which each of one or more power supplies, one or more lighting fixtures, one or more emitting surfaces and one or more connectors are interchangeable while maintaining a target photosynthetic photon flux density (PPFD) at a canopy of a plant bed having a specified area.

### BRIEF DESCRIPTION OF THE DRAWINGS

FIG. 1 is a block diagram illustrating a modular lighting fixture in accordance with various implementations.

FIG. 2 is a block diagram of a modular horticultural lighting system in accordance with various implementations.

FIG. 3 is a chart of variable parameters that may be changed in a modular horticultural lighting system in accordance with various implementations.

FIGS. 4A-4C are block diagrams showing different variations of an adaptable horticultural lighting system that meet the same lighting needs in accordance with various implementations.

FIG. 5 shows examples of interchangeable components in a modular horticultural lighting system in accordance with various implementations.

FIG. 6 is a block diagram of a modular horticultural lighting system with interchangeable connector components in accordance with various implementations.

FIG. 7 are block diagrams illustrating different interchangeable connector components that support that same number of lighting fixtures in accordance with various implementations.

FIG. 8 are block diagrams illustrating different modular horticultural lighting systems that deliver the same wattage in accordance with various implementations.

FIGS. 9A-9B are block diagrams illustrating dynamic reconfiguration of modular horticultural lighting systems in accordance with various implementations.

FIG. 10 is a flow chart illustrating a method of determining a lighting solution for a customer using a modular horticultural lighting system in accordance with various implementations.

FIG. 11 is a flow chart illustrating a sales process for modular horticultural lighting systems in accordance with various implementations.

These and other features of the present implementations will be understood better by reading the following detailed description, taken together with the figures herein described. The accompanying drawings are not intended to be drawn to scale. For purposes of clarity, not every component may be labeled in every drawing.

### DETAILED DESCRIPTION

### Modular Fixture and Lighting System

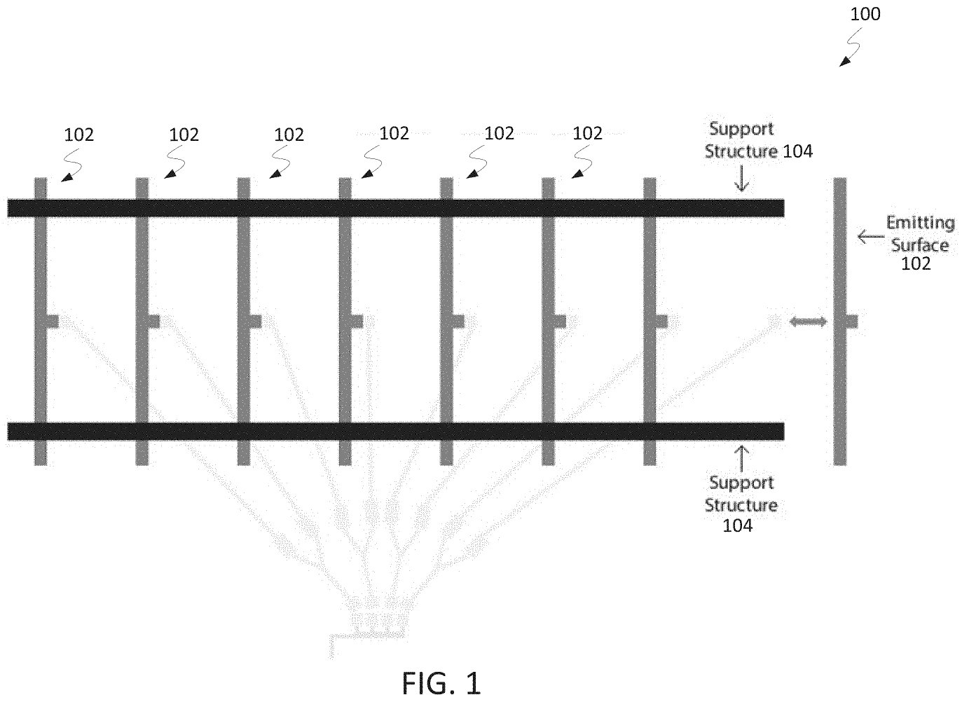

FIG. 1 is a block diagram illustrating a modular lighting fixture 100 in accordance with various implementations. The modular lighting fixture 100 includes a plurality of emitting surfaces 102. The emitting surfaces 102 may be, for example, light bars that include a number of light emitters (e.g., light emitting diodes, or LEDs) and associated power and/or control circuitry. While the emitting surfaces 102 illustrated in FIG. 1 are linear/rectangular in shape, in general the emitting surfaces 102 may have any shape configuration, such as circular or area-wide (e.g., square).

The emitting surfaces 102 may be removably coupled to support structures 104. For example, support structures 104 may include one or more rails on which the emitting surfaces 102 may be coupled. In some implementations, the emitting surfaces 102 may slide along the support structures 104 such that the spacing between the emitting surfaces may be customized. In some implementations, the emitting surfaces 102 may be attached so they are perpendicular to the support structures 104. In other implementations, the emitting surfaces 102 may be attached so they are non-perpendicular to the support structures 104 (e.g., mounted at an angle). The support structures 104 may include cables or wiring that may be connected to each emitting surface 102 in order to provide power and/or control signals. In some implementations, the emitting surfaces 102 may be connected in parallel in order to increase flexibility and the ability to redistribute light in case one or more of the emitting surfaces 102 fail. In other implementations, the emitting surfaces 102 may be connected in series to reduce line/ohmic losses.

While two support structures 104 are illustrated in FIG. 1, in general the modular lighting fixture 100 may include any number of support structures. The modular lighting fixture 100 may include other components not illustrated in FIG. 1, such as drivers, controllers, sensors, and wired or wireless communication modules. These components may be incorporated into the emitting surfaces 102 or support structures 104, or be attached to them.

Emitting surfaces 102 may be added to or removed from the modular lighting fixture 100 and the spacing between each one may be changed and customized. The geometry of the modular lighting fixture 100 is customizable to meet specific customer lighting needs. For example, given a customer's PPFD/uniformity requirements, the number and spacing of the emitting surfaces 102 may be adjusted and the wattage of the system may be set to exactly or closely meet the PPFD/uniformity requirements. Thus the modular lighting fixture 100 provides greater flexibility than fixed lighting systems in which the wattage and geometry of the fixtures are static.

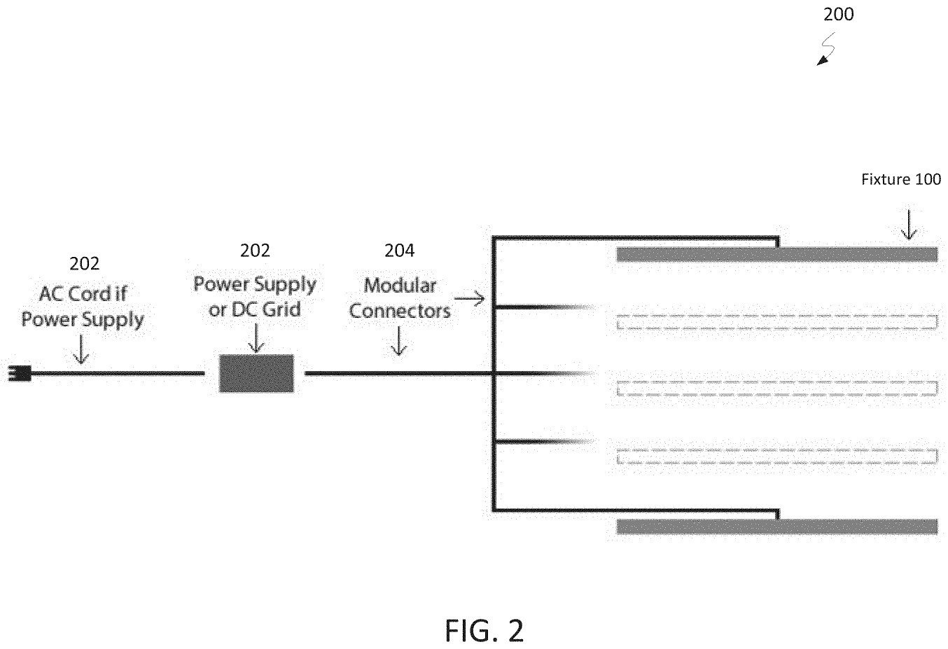

FIG. 2 is a block diagram of a modular horticultural lighting system 200 in accordance with various implementations. The horticultural lighting system 200 includes one or more power sources 202, which may be power supplies and associated AC cords or DC grids. The power sources 202 are connected to one or more modular lighting fixtures 100 (described with reference to FIG. 1) via modular connectors 204. Each power source 202 may provide power at a different wattage. One or more of the power sources 202 may be connected to one or more of the modular lighting fixtures 100 based on customer requirements. For example, the power sources 202 and modular lighting fixtures 100 may be connected in such a way to achieve specific uniformity targets over a comprehensive area of analysis (e.g., to control cost and accommodate customer lighting goals) or to vary intensity across specific sections of a comprehensive area of analysis (e.g., to accommodate varying intensity targets for specific plant varieties/stages of growth). The modular connectors 204 allow for flexible connections between the power sources 202 and the emitting surfaces 102 on the modular lighting fixtures 100, and specifically allow for dynamic addition, removal, and reconfiguration of the emitting surfaces 102.

The horticultural lighting system 200 allows individual emitting surfaces to be driven at varying wattages based on the number of emitting surfaces connected to the system. For example, a 600 direct current (DC) watt (W) power supply may be connected to one or more modular lighting fixtures 100 that collectively have a total of six emitting surfaces. Thus each emitting surface draws 100 DC W of power. Adding a seventh emitting surface means the wattage of the power supply/DC grid 202 is redistributed so that all seven emitting surfaces draw 85.7 DC W each.

Given a target irradiance (PPFD) and the geometry of the system (e.g., area and mounting height), the required wattage of the system may be calculated, along with the optimal number of emitting surfaces and the distance between emitting surfaces. Utilizing the horticultural lighting system 200 allows a customer to easily change the hardware and emitting surfaces used in the system without altering the total wattage used by the system. This flexibility of componentry also addresses the other constraint imposed by the customer: costs. Modular lighting systems also allow customers to balance cost with performance. For example, if the optimal solution is too costly, it is easy to remove components to achieve the desired costs if trade-offs are made with uniformity, irradiance or the distance between the illuminated area and the emitting surfaces.

One major advantage of a modular lighting system over a fixed system is the ability to decouple the number of emitting surfaces from the wattage (total power) of the system. It allows a complex problem to be solved when only two non-dependent variables are known: uniformity and irradiance. While these two attributes are intimately linked in a fixed lighting system, they are separate and independently manipulatable in a modular lighting system. Having discrete control of these two variables allows for design of a much wider range of applications while allowing optimization of performance, cost or even componentry to enable the best physical fit.

The horticultural lighting system 200 may include other components not shown in FIG. 2. For example, the horticultural lighting system 200 may include a driver that is configured to divert power to specific emitting surfaces on an application by application basis to meet customer uniformity or intensity goals. The horticultural lighting system 200 may also include sensors for monitoring environmental or plant parameters, and communication modules for communicating with the servers and/or user devices 206. The horticultural lighting system 200 may be connected to one or more computing devices, such as user devices (e.g., tablets, laptops, smart phones) and servers, to enable cloud storage, cloud computing, and smart farming functionality. For example, the computing devices may provide remote monitoring and control functions for the horticultural lighting system 200 (e.g., receiving sensor data from the horticultural facility and analyzing the data to detect anomalous conditions or to monitor plant growth and provide suggestions for improving plant growth through lighting or other environmental controls). In another example, a grower or customer may be able to remotely monitor and control the horticultural lighting system 200 with a user device connected to the system.

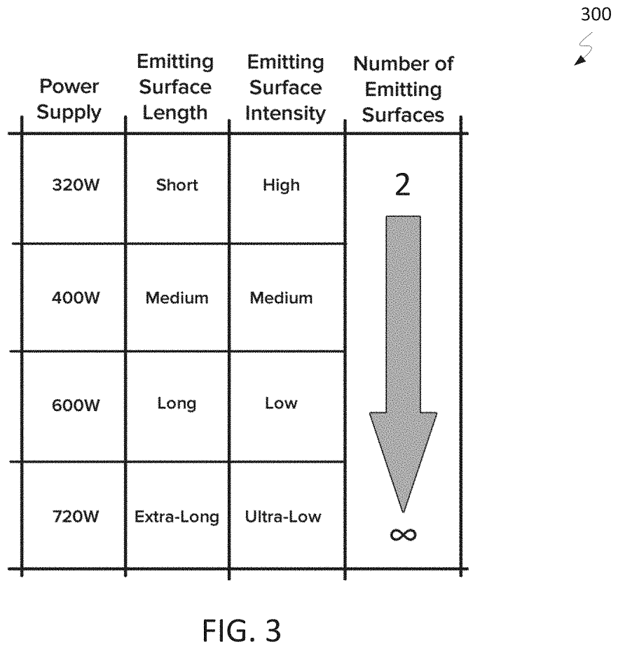

FIG. 3 is a chart 300 of variable parameters that may be changed in a modular horticultural lighting system in accordance with various implementations. Each column in the chart 300 represents an independent variable that may be adjusted in the horticultural lighting system 200 and the modular lighting fixture 100. The variables include the wattage of the power supplies available, the length of the emitting surface (e.g., the length of a linear light bar), the intensity of the emitting surface, and the number of emitting surfaces used. Given a target uniformity, PPFD, and geometry (e.g., area to be illuminated and mounting height), the power supply wattage and emitting surface parameters may be selected to achieve the target specifications. For example, the optimal solution may include determining the smallest power supply to achieve a fixed total wattage, the right size of the emitting surfaces to satisfy geometric constraints, or the total number of emitting surfaces.

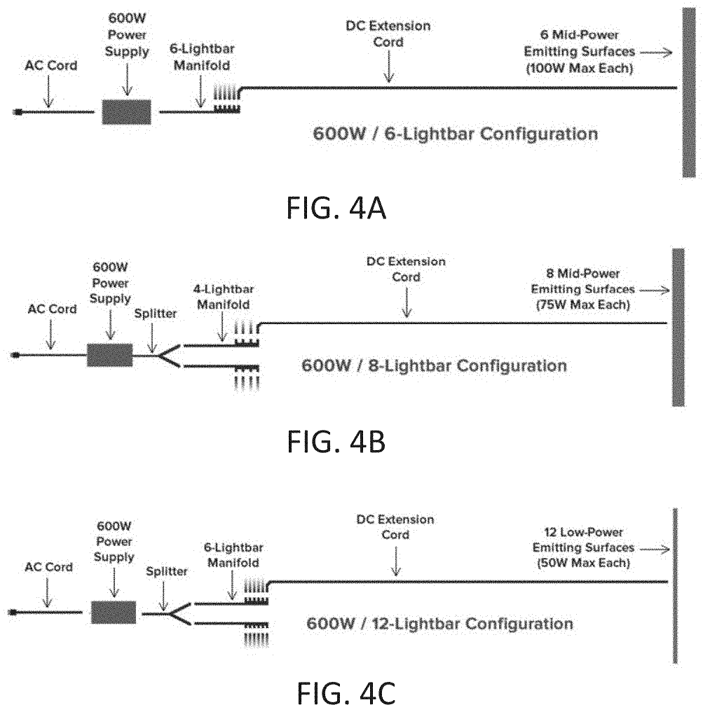

FIGS. 4A-4C are block diagrams showing different variations of a modular horticultural lighting system that meet the same lighting needs in accordance with various implementations. The following is an example of how the horticultural lighting system 200 can adjust to the changing needs of a customer. Suppose a customer desires illumination of approximately 450 PPFD over a 4 feet by 8 feet canopy. Given the geometry constraints and PPFD target, the lowest cost solution is determined to be a 600 W power supply powering six 100 W emitting surfaces (light bars in this example) spaced 1 foot 4 inches apart, and mounted 1 foot 4 inches above the canopy. This solution is shown in FIG. 4A. At 1 foot 4 inches above the canopy, this solution delivers the targeted intensity (PPFD) with optimal uniformity, but the customer is worried about mounting height as there will be multiple tiers of crops stacked on top of one another. To help maximize existing vertical space and fit more tiers into the same footprint, the light bars may be lowered closer to the canopy, but the uniformity will decrease to unacceptable levels.

To reduce mounting height, the customer may opt to add light bars to the solution. A higher cost solution that meets the customer's new performance targets is illustrated in FIG. 4B: eight 75 W light bars spaced 1 foot apart, and mounted 1 foot above the canopy. This solution meets the PPFD and uniformity targets, is smaller height-wise than the first solution (the distance between lights and canopy decreases by 4 inches), and the total wattage remains unchanged because the 600 W power supply redistributes the power evenly among the eight light bars, leading to each light bar consuming 75 W.

Suppose now that the customer wishes to reduce their electrical bill (operating expenditure, or OpEx) by improving the efficacy of the solution. Readjustment of the variables in the modular lighting system leads to the solution shown in FIG. 4C: twelve light bars spaced 8 inches apart, and mounted 8 inches above the canopy. The resulting solution reduces the vertical height of the solution by a further 4 inches as compared to FIG. 4B while still maintaining the customer's PPFD and uniformity targets. More importantly, the addition of four more light bars means that each light bar is now driven at a lower wattage, increasing the efficacy of each light bar and the system. The power supply redistributes the 600 W evenly among the twelve light bars such that each light bar consumes 50 W. In a further optimization, the mid-power light bars capable of handling 100 W and 75 W may be replaced by cheaper low power light bars. While increasing the number of light bars increases the cost, it is at least partially offset by using cheaper parts.

It is noted that the uniformity, PPFD, and total wattage are the same across the solutions shown in FIGS. 4A-4C. The only parameters that changed were the number of light bars, the spacing between light bars, and the wattage supplied to each light bar. Thus the horticultural lighting system 200 is capable of adjusting certain variables (e.g., mounting height, cost) while maintaining the same irradiance and uniformity requirements. Even after the initial set-up, the horticultural lighting system 200 is capable of easily transforming between the solutions shown in FIGS. 4A-4C— the only changes that need to be made are to the mounting height and the addition/removal of light bars. Contrast this to a fixed lighting system in which the whole system (including the power supply, connectors, and fixtures) may need to be swapped out in order to accommodate different lighting and geometry needs.

### Interchangeable System Components

Flexibility in the modular horticultural lighting system is not limited to the emitting surfaces themselves, but may also extend to other components that make up the system as a whole. Modular horticultural lighting systems may also include power supplies and connector components that connect the power supplies to the emitting surfaces. While the emitting surfaces share wattage, and dynamically redistribute wattage based on the number of components attached, the power supplies and the connectors may be equally modular and interchangeable. When the entire system is standardized on a common set of specifications, any given component is easily interchangeable without the remainder of the system needing to be adjusted or replaced.

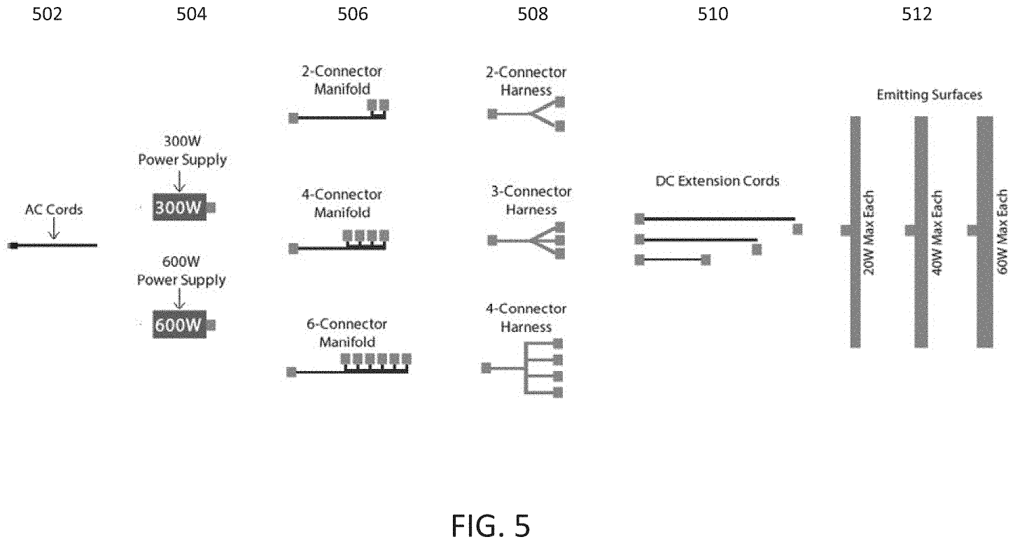

FIG. 5 shows examples of interchangeable components in a modular horticultural lighting system in accordance with various implementations. The interchangeable components may include an AC cord 502 that may connect to a variety of AC power supplies 504. In some implementations, when the modular horticultural lighting system is run off a DC grid, the AC cord 502 may instead be a DC cord and there is no AC power supply 504. In some implementations, there may be more than one power supply in the system. The power supplies are used to deliver the required amount of total DC wattage (W_{DC}) used to drive all the emitting surfaces at the proper voltage (V_{DC}) for each individual emitting surface. Power supplies come in a range of power levels and in a range of output voltages. For a lighting system to function, the power supply's W_{DC} and V_{DC} must match the W_{DC} and V_{DC} requirements of the emitting surfaces. In a modular horticultural lighting system, all possible emitting surfaces and power supplies must share common W_{DC} and V_{DC} electrical specifications.

If a power supply fails it may be replaced without changing or uninstalling any other component. The power supply can also be replaced with a higher or lower output power supply to moderate the intensity of light without altering uniformity or changing or uninstalling any other components. Alternately, multiple modular lighting systems' power supplies may be replaced with power from a DC grid. A DC grid is powered by a large, centrally located power supply that outputs a large amount of wattage. Pairing multiple modular lighting systems with a DC grid at the time of installation offers significant labor and material savings as multiple power supplies are replaced with only one. The DC grid may also be reconfigured later to accommodate new electrical requirements, more modular lighting systems, or other components (i.e. fans, motors, irrigation pumps & sensors) with no required change to the placement or performance of the systems connected to the grid.

Modular horticultural lighting systems may also include a number of different cabling/connectors between the AC power supplies 504 and emitting surfaces 512. These connectors may include a variety of different manifolds 506, a variety of different harnesses 508, and a variety of DC extension cords 510. Other kinds of interchangeable components not shown in FIG. 5 may also be part of a modular horticultural lighting system. The manifolds 506 may be used to connect the AC power supplies 504 to the harnesses 508. Different manifolds 506 may have different number of connectors, each connector configured to connect with a harness 508. For example, a 2-connector manifold may connect an AC power supply 504 to two harnesses 508, while a 4-connector manifold may connect an AC power supply 504 to four harnesses 508, while a 6-connector manifold may connect an AC power supply 504 to six harnesses 508.

Similarly, the harnesses 508 may have different numbers of connectors, each connector configured to connect to an emitting surface 512 with or without a DC extension cord 510 in between. For example, a 2-connector harness may connect a manifold to two emitting surfaces, while a 3-connector harness may connect a manifold to three emitting surfaces, while a 4-connector harness may connect a manifold to four emitting surfaces. Each DC extension cord 510 may be used to connect the harnesses 508 to the emitting surfaces 512. If DC extension cords 510 are used between the harnesses and the emitting surfaces, they may come in varying lengths, such as short, medium, and long, depending on the spatial needs of the system setup.

Each of the AC cord 502, AC power supplies 504, manifolds 506, harnesses 508, DC extension cords 510, and emitting surfaces 512 may be interchangeable such that they may be easily replaced in case of failure of any one of the components, or when the lighting requirements of the system change. For example, if the number of emitting surfaces supported by a harness is increased from three to four, the 3-connector harness may be replaced by a 4-connector harness. In another example, if one of the manifolds in the system fails, it may be replaced without changing any of the other components. Each of the various interchangeable components use the same connector type so that any component may be easily replaced without worrying about compatibility of connection points. Thus the interchangeable components enable a fully flexible and adaptable modular horticultural lighting system in which the system is easily changed to meet a variety of lighting demands, and can be easily repaired when components fail.

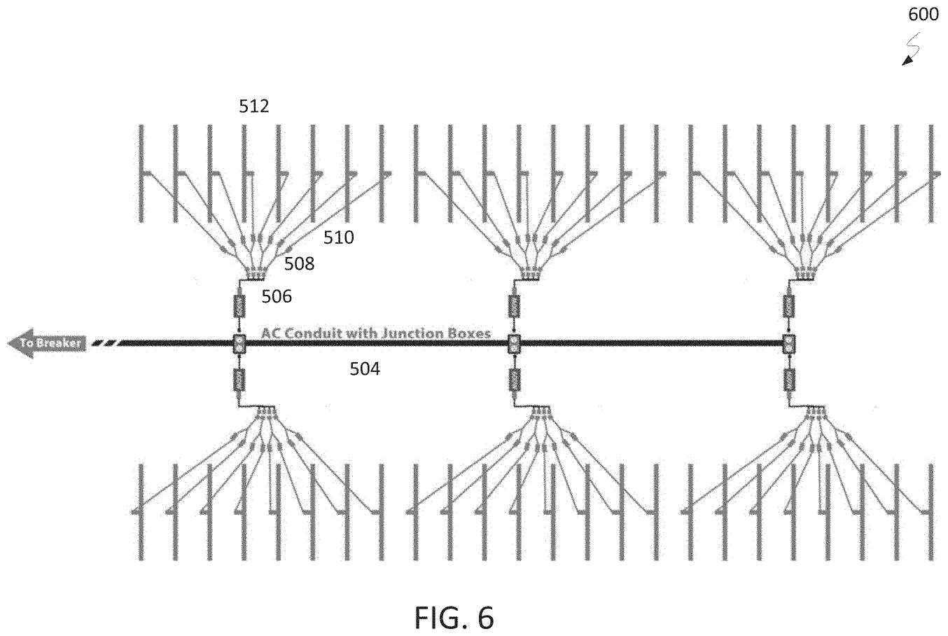

FIG. 6 is a block diagram of a modular horticultural lighting system 600 with interchangeable connector components in accordance with various implementations. The modular horticultural lighting system 600 includes a number of the interchangeable components shown in FIG. 5. For example, an AC power supply 504 may be connected to a number of manifolds 506 (in this case, 4-connector manifolds), each of which are connected to a number of harnesses 508 (in this case, 2-connector manifolds). Each harness is connected to a DC extension cord 510, which is connected to an emitting surface 512. By changing any of the parts in system 600, the number of emitting surfaces may be changed to meet any specific lighting needs. In addition, any of the parts in system 600 may be replaced without affecting any other part, making the replacement of failed parts easy.

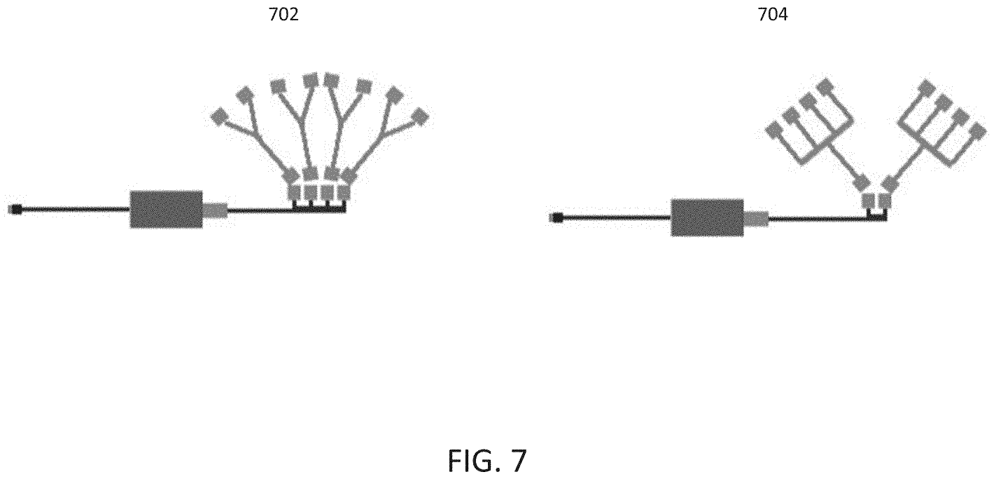

FIG. 7 are block diagrams illustrating different interchangeable connector components that support that same number of lighting fixtures in accordance with various implementations. In configuration 702, an AC cord is connected to a 4-connector manifold. Four 2-connector harnesses are connected to the 4-connector manifold, supporting a total of eight emitting surfaces. In configuration 704, an AC cord is connected to a 2-connector manifold. Two 4-connector harnesses are connected to the 2-connector manifold, again supporting a total of eight emitting surfaces. FIG. 7 is an example of how the same lighting requirements may be met using different sets of components. This allows for greater flexibility in building modular horticultural lighting systems and lessens the need to have specific parts on hand in order to meet specific lighting requirements.

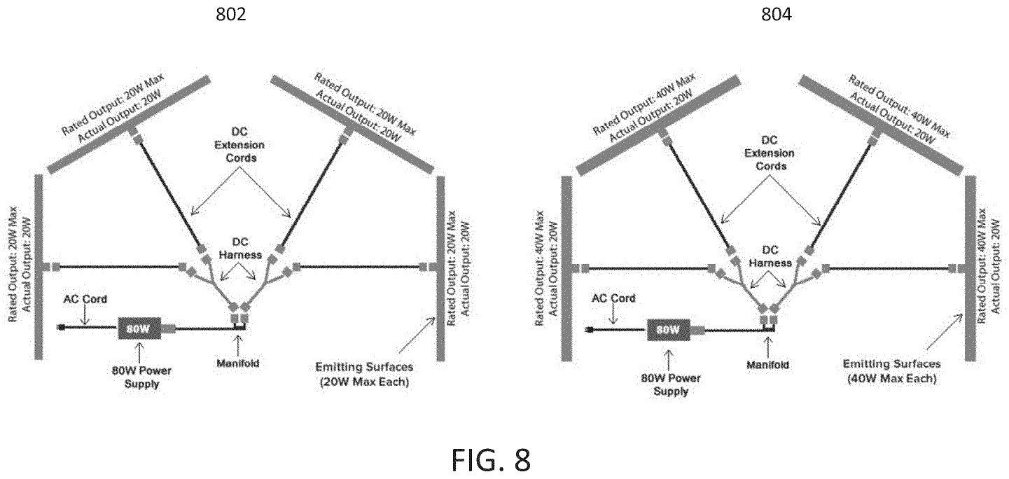

FIG. 8 are block diagrams illustrating different modular horticultural lighting systems that deliver the same wattage in accordance with various implementations. In configuration 802, an AC power supply delivering 80 W of power is connected to a 2-connector manifold. Two 2-connector harnesses are connected to the 2-connector manifold, supporting a total of four emitting surfaces, each rated at 20 W and receiving 20 W of power. Thus, each emitting surface delivers 20 W of power. Configuration 804 is similar to configuration 802 except that the four emitting surfaces are each rated at 40 W but receiving only 20 W of power. However, because only 80 W is being delivered to the system and the 80 W of power is split equally among the emitting surfaces, each emitting surface again delivers 20 W of power. This is another example of how the same lighting requirements may be met using different sets of components.

There are several benefits to having a range of emitting surface options to choose from. For example, during the design process emitting surfaces may be replaced with higher or lower intensity (wattage) options as the total system wattage and design goals change. Changing emitting surfaces in the design process requires no change to any other components unless the wattage required for each emitting surface exceeds the maximum rating for that emitting surface. In addition, if an emitting surface fails after deployment, it may be easily replaced with no change to the rest of the system. The remaining system will compensate by outputting more light per emitting surface until the failed emitting surface is replaced. The modular power architecture of the system will still deliver the same total wattage over a given area even when one or more emitting surfaces are disconnected. Furthermore, having a range of emitting surfaces with varying outputs (e.g., 30 W, 60 W, 90 W) offers significant advantages for supply chain and warehousing. If inventory levels for a 30 W emitting surface are depleted, any higher wattage emitting surface in the platform may be substituted to fulfill the order, such as the example shown in FIG. 8. The order may be a little more costly to fulfill, but the customer still receives a solution.

There are additional general benefits to a modular horticultural lighting system in which each component is interchangeable. For example, if any component in a modular lighting system fails it may be replaced individually, without sending the rest of the system back for replacement. Shipping a single emitting surface, power supply, or cable/connector saves on shipping cost and requires less time to fulfill. In contrast, when replacing a component in a fixed system, the whole system or a majority of it must be replaced, thus incurring higher shipping charges while replacing fully functional components that can't be easily detached from the larger system. Furthermore, at any time after deployment/installation, the modularity of the system allows it to be reconfigured easily. Not only can the emitting surfaces be respaced to meet new uniformity/intensity goals, but the system may even be divided among two or more new geometries without changing any components. Thus modularity offers substantially more flexibility than a fixed system.

### Excess System Wattage Usage

Modular horticultural lighting systems may include other components aside from those shown in FIG. 5, such as components that help measure and/or control the environmental variables and conditions in the grow environment. Additional components that may be incorporated into the system may include, but are not limited to, fans, heaters, sensors, control devices (e.g., pumps, solenoids, and switches), as well as other peripheral equipment that run on DC power.

These additional components may also be powered by the modular horticultural lighting system if there is more wattage that needed to achieve the customer's lighting requirements. Each component may include or be connected to a current limiter so that they do not draw more power than needed away from the emitting surfaces. For example, a modular horticultural lighting system may include a 600 W DC power supply and 20 emitting surfaces that only require 25 W of power to meet the customer's light intensity target. The emitting surfaces utilize a total of 500 W of power, which means there is 100 W of power left over. This excess wattage may be used to power other components in the system, for example a DC fan that requires 100 W of power. The DC fan may have a built-in current limiter or be connected to a current limiter so that it never draws more than 100 W of power and therefore would not compromise the wattage provided to the emitting surfaces and/or overload the power supply. In an alternate example, a 50 W DC fan, a 45 W DC heater, and five 1 W sensors may all be connected to the 600 W power supply. These components draw a total of 100 W of power, leaving 500 W for the emitting surfaces.

Thus the modular horticultural lighting system may be used to power additional non-lighting components, which results in fewer cabling, outlet usage, and labor to set up. This in turn may lead to labor and cost savings. Because the wattage of the power supply and lighting wattage requirements may be determined at the time the system is designed, it becomes easy to incorporate peripheral devices into the system to use up excess wattage. The peripheral devices may be selected based on the power that each device draws compared to the amount of excess wattage available, and each peripheral device may include a current limiting component so that they do not compromise performance of the system Peripheral devices may also be replaced, added, or removed after installation of the system as well as long as the power restrictions of the total system are not violated.

### Dynamic Reconfiguration to Minimize Yield Losses

Another beneficial feature of the modular horticultural lighting system disclosed herein is the ability to electrically reconfigure the components in order to dynamically redistribute total system PPF (measured in μmol/s) when any one or more emitting surfaces fail. The power may be redistributed to the remaining emitting surfaces in a manner that retains the same or similar PPFD (measured in μmol/m²/s) to the original configuration. This is made possible because there is a constant current power supply that provides a set amount of current to the system architecture. All emitting surfaces connected to the system architecture will equally share that current. As emitting surfaces are added or removed from the system, the current will automatically be rebalanced and be shared equally among the remaining emitting surfaces. In some implementations, emitting surfaces may not have a driver that limits current, so the constant current power supply may be configured to limit the amount of power each emitting surface may draw (e.g., a limit of 55 W DC) so that the emitting surfaces do not draw excess power which may damage them.

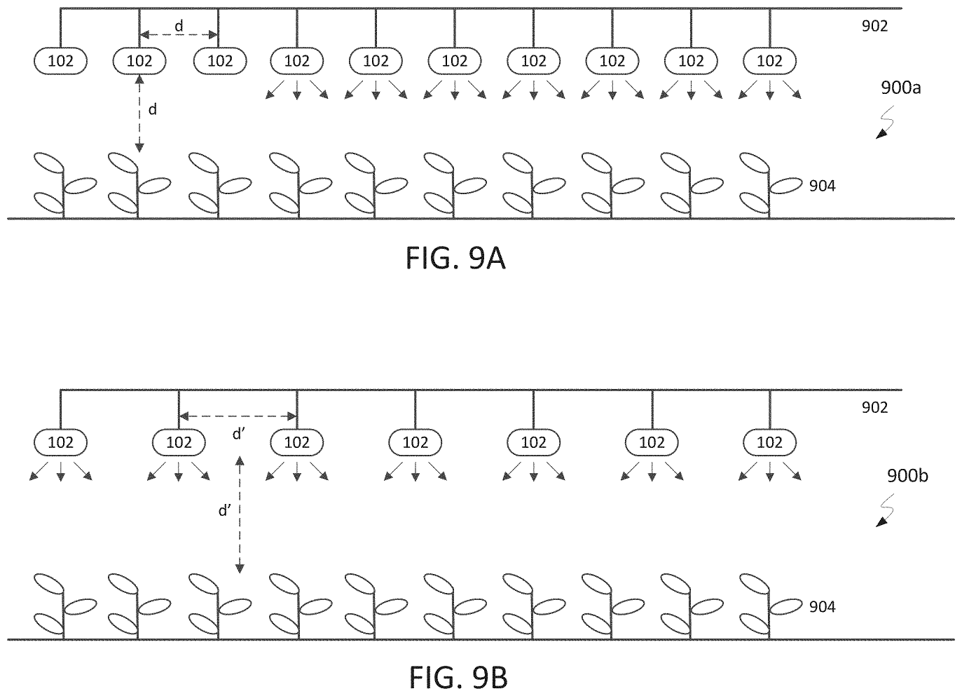

FIGS. 9A-9B are block diagrams illustrating dynamic reconfiguration of modular horticultural lighting systems in accordance with various implementations. FIG. 9A shows a modular horticultural lighting system 900a having a plurality of emitting surfaces 102 connected to a constant current power supply via connectors 902. The connectors 902 may include any number of manifolds, harnesses, and extension cords as shown in FIG. 5. The emitting surfaces 102 may be connected in a parallel wiring scheme. The emitting surfaces 102 may illuminate a plant bed 904. There are ten emitting surfaces 102 illustrated in FIG. 9A, but in general the system 900a may include any number of emitting surfaces 102. There may be a one-to-one correspondence between the distance between each emitting surface 102 and the distance between the emitting surfaces 102 and the canopy of the plant bed 904 (denoted as d in FIG. 9A). This one-to-one correspondence may provide optimal light uniformity for the plant bed 904 assuming the emitting surfaces 102 have a 120° angle of emission. For other angles of emission, there may be a different optimal ratio between emitting surface spacing and mounting height. In the example shown in FIG. 9A, the left three emitting surfaces 102 have failed and are no longer illuminating the plant bed 904. This means that the plant bed 904 is not illuminated uniformly, and thus the plants may experience uneven growth conditions, which may be problematic. In addition to the loss in uniformity, the reduction in PPF has a direct correlation to yield. For example, for some cultivars a 1% loss in light (PPF) may result in a 1% decrease in yield (grams/ft²).

FIG. 9B shows a modular horticultural lighting system 900b in which the emitting surfaces 102 have been reconfigured in light of the emitting surface failures shown in FIG. 9A. Specifically, the three failed emitting surfaces have been removed. The remaining seven emitting surfaces 102 are moved so that they cover the entire length of the plant bed 904. The distance between each emitting surface is now d′. The distance between the emitting surfaces 102 and the canopy of the plant bed 904 is also changed to equal d′ so that the one-to-one correspondence is retained. The power supplied by the power supply is evenly redistributed among the remaining emitting surfaces 102. For example, if in FIG. 9A the power supply supplied a total of 350 W DC, then each of the ten emitting surfaces 102 would draw 35 W of power. In FIG. 9B, the power supply remains unchanged but there are now seven emitting surfaces 102, so each one would draw 50 W of power.

Once the emitting surfaces 102 are rearranged to a wider spacing and the mounting height of the emitting surfaces 102 above the canopy is adjusted to match the spacing between the emitting surfaces 102, the total intensity of light on the canopy of the plant bed 904 should have a nominally similar PPFD to the original configuration, only losing a few points of coefficient of utilization U (a variable between 0 and 1). The uniformity of light intensity will also be similar to the original configuration. This means that the reconfigured modular horticultural lighting system will have a nominally similar intensity and uniformity to the original configuration, even with fewer emitting surfaces. This reconfiguration is quick and easy to accomplish while still retaining the same or similar system PPF and photosynthetic capacity, which in turn maintains the same or similar yield/biomass production.

The average PPFD of the modular horticultural lighting system may be expressed as PPFDₐᵥₑ=((Fixture quantity)×PPF_{LES}×U)/M2, in which PPF_{LES} is the PPF of each emitting surface, M2 is the area of the canopy of the plant bed, and U is the variable input and negatively correlates with mounting height and/or room size. By taking the additional PPF that is redistributed to the new number of emitting surfaces and rearranging the emitting surfaces both outward and upward to hit a uniformity target, the coefficient of utilization trends down in relation to the mounting height. This nominal loss in the coefficient of utilization is not nearly as detrimental to plant growth as a reduction in PPFD and the loss of uniformity that would result if the system is not reconfigured after failure of one or more emitting surfaces.

The following is a numerical example of rebalancing of PPFD in a modular horticultural lighting system. The system may have 16 emitting surfaces illuminating a plant bed with a canopy area of 2.97 m², a coefficient of utilization of 0.94, and a PPF per fixture of 190 μmol/s. The resultant average PPFD is (16×190×0.94)/2.97=958 μmol/m²/s. If four of the 16 emitting surfaces fail, the PPF per fixture is redistributed evening among the remaining emitting surfaces, resulting in a PPF_{LES} of 253 μmol/s. The average PPFD is now (16×253×0.94)/2.97=969 μmol/m²/s. However, the light distribution is not uniform—there is less light illuminating the parts of the plant bed below the failed emitting surfaces and more light illuminating the rest of the plant bed. This results in over-lighting of some of the plant bed and under-lighting of other parts of the plant bed, which negatively impacts crop yield.

The failed emitting surfaces may be removed and the 12 remaining emitting surfaces are reconfigured to span the plant bed. The mounting height is increased by 2 inches in order to maintain the one-to-one correspondence with emitting surface spacing. The change to mounting height changes the coefficient of utilization to 0.91. The final average system PPFD is now (12×253×0.91)/2.97=925 μmol/m²/s. This is lower than the original PPFD, but the light is uniformly distributed throughout the plant bed, which maintains a similar crop yield to the original configuration without a large loss in system PPFD. In this way, the modular horticultural lighting system may be quickly and easily reconfigured in case of emitting surface failures in order to preserve the same or similar lighting and crop growth conditions. When replacement parts have arrived, the system may easily be reverted to the original configuration.

### Lighting Solution Optimization

As discussed previously, modular horticultural lighting systems may be prototyped and modified quickly at the design stage to accommodate changes in a customer's lighting requirements and preferences. Given a set of customer specifications for a lighting installation, there may be many permutations of components in the modular horticultural lighting system that would satisfy the customer specifications. However, some solutions would be more optimal than others based on a variety of factors. For example, certain permutations may cost less in terms of component parts or may consume less power than other permutations.

However, implementations disclosed herein provide a quick and easy way to determine and re-determine the optimal lighting solution for a customer based on a customer's input specifications using a lighting solution calculator. This calculator allows a person (e.g., a salesperson) to quickly calculate the optimal lighting solution for a customer based on the input parameters. The “optimal” solution for a particular customer may depend on the customer's priorities and a variety of criteria, such as space constraints, cost, energy usage, system efficiency, and crop growth targets. If the customer is not satisfied with the solution, changes to various parameters may be made and new lighting solutions may be quickly recalculated until the customer finds a solution that they are satisfied with. This allows a salesperson and customer to settle on a final lighting solution in a matter of minutes or hours rather than weeks.

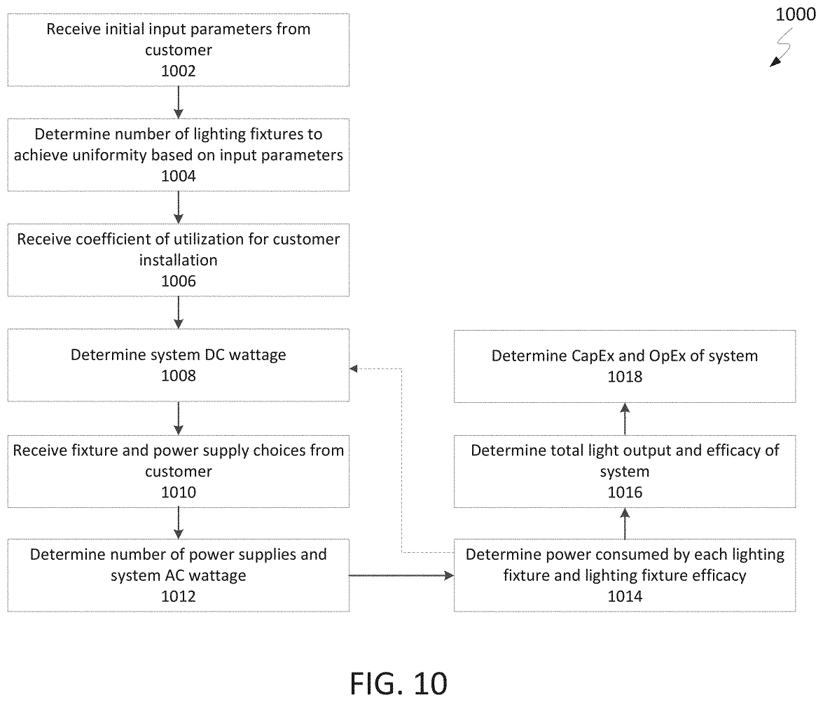

FIG. 10 is a flow chart illustrating a method 1000 of determining a lighting solution for a customer using a modular horticultural lighting system in accordance with various implementations. The method 1000 may be implemented as instructions stored on a non-transitory computer readable medium, that when executed by a processor performs the method. The method may be embodied within an application, a script, a webpage, or other program (e.g., a spreadsheet) executing on a computing device, such as a desktop, laptop, tablet, or smart phone.

The method 1000 begins by receiving initial input parameters from the customer in block 1002. The initial input parameters may include the dimensions of the customer's grow surface. For example, the grow surface may be a rectangular plant bed and the dimensions of the grow surface would be a width (w) and a length (l) of the plant bed. The initial input parameters may also include a mounting height (h) of the lighting fixtures above the grow surface. The dimensional inputs w, l, and h may be expressed in units of meters. The initial input parameters may also include an average desired PPFD E at the grow surface. The PPFD may be expressed in units of μmol/m²s. If the method 1000 is performed by an application executing on a computing device, the application may provide a user interface with input fields for the initial input parameters.

In block 1004, the application may determine the number of lighting fixtures to achieve light uniformity at the grow surface based on the initial input parameters. The number of lighting fixtures N_{L} for achieving light uniformity at the grow surface may be calculated as:

N_{L}=lk/h Equation (1)

in which l is the length of the grow surface, h is the mounting height of the fixtures above the grow surface, and k is an adjustable coefficient to adjust lighting fixture spacing for varying light distributions. The relationship in Equation 1 is based on the distribution of light from bar-shaped lighting fixtures, which yields peak uniformity on a receiving plane (e.g., grow surface) with a set relationship between the distance of the fixtures from the receiving plane and the distance between the fixtures. For this calculation, it may be assumed that there is a one-to-one relationship between the spacing between each lighting fixture and the mounting height (e.g., each lighting fixture is a distance h from adjacent lighting fixtures).

In block 1006, the application may receive a coefficient of utilization U of the customer's installation. The coefficient of utilization is a non-dimensional parameter that is experimentally determined by analysis of the customer's grow environment and facilities and is a measure of the efficiency of light utilization by the grow environment when lighting fixtures have been installed. For example, the salesperson or someone else from the company that is selling the modular horticultural lighting system may calculate the coefficient of utilization through lighting design simulation of the customer's grow environment, and enter the value into the application.

In block 1008, the application may determine the required DC wattage for the modular horticultural lighting system based on the number of lighting fixtures that are in the system. Specifically, the luminous power of the lighting fixtures at the grow surface P_{system,DC}, measured in watts, may be calculated as:

P_{system,DC}Ewl/εₗU Equation (2)

in which E is the average PPFD at the grow surface, w is the width of the grow surface, l is the length of the grow surface, U is the coefficient of utilization, and εₗ is lighting fixture efficacy measured in units of μmol/J. The lighting fixture efficacy may be determined experimentally by measuring the light output of the lighting fixture at various wattages, as described further herein.

In block 1010, the application may receive the specific type of lighting fixture and power supply chosen by the customer for use in the modular horticultural lighting system that satisfy the DC wattage determined in block 1008. For example, there may be a number of different lighting fixtures and power supplies that may be used in the modular horticultural lighting system, and the customer may select the lighting fixture and the power supply for used in the system based on a variety of factors (e.g., power consumption, size, cost). For example, the application may provide a drop-down menu or another type of input selection method that allows the user to select from a range of lighting fixtures and power supplies that satisfy the DC wattage requirement. The application may then extract certain parameters for the selected power supply. For example, the application may determine the maximum DC power P_{DC} provided by the selected power supply, measured in watts. This parameter is an inherent reference characteristic of the power supply and may be obtained from the product specification sheets for the power supply. The application may also determine the power supply efficiency η at the system service voltage, which may be determined by testing the power supply or may be derived from the product specification sheets.

In block 1012, the application may determine the number of power supplies that satisfy the system's DC wattage calculated in block 1008, and the system's AC wattage requirements. The number of power supplies N_{PS} needed to satisfy the system's DC power requirements may be calculated as:

N_{PS}=P_{system,DC}/P_{DC} Equation (3)

in which P_{system,DC} is the luminous power at the grow surface and P_{DC} is the maximum DC power of the selected power supply. The system's required AC power P_{system,AC} in units of watts may be calculated as:

P_{system,AC}=P_{system,DC}/η Equation (4)

in which P_{system,DC} is the luminous power at the grow surface, and η is the efficiency of the selected power supply at the service voltage.

In block 1014, the application may determine the power consumed by each lighting fixture in the modular horticultural lighting system and lighting fixture efficiency. The system's DC wattage is divided among the number of lighting fixtures N_{L} in the system. Therefore the power consumed by each lighting fixture P_{L} is calculated as:

P_{L}=P_{DC}/N_{L} Equation (5)

in which P_{DC} is the maximum DC power of the selected power supply. The efficacy εₗ of each lighting fixture may then be calculated as:

εₗ=Φ/P_{L} Equation (6)

in which Φ is photosynthetic photon flux (PPF) measured in units of μmol/s. The PPF may be determined directly from experimental measurements on the lighting fixture or indirectly from an empirically based trendline. For example, PPF data may be collected by measuring light output across a range of wattages for each type of lighting fixture to create a confirmed correlation between wattage and PPF, or may be derived from trendlines of the PPF data.

In some implementations, the efficacy of the lighting fixture calculated in block 1014 may be fed back into block 1008 in an iterative process. For example, when the DC wattage is calculated for the first time, an estimate of the efficacy may be used in Equation 2. After the efficacy εₗ is calculated in block 1014, the application may return to block 1008 to recalculate the DC wattage with the new efficacy value. This loop may continue one more times until the calculated efficacy does not vary above a certain threshold from iteration to iteration.

In block 1016, the application may determine the total light output and efficacy of the modular horticultural lighting system. The photometric output of the system Φ_{system} may be calculated as:

Φ_{system}=N_{L}Φ Equation (7)

in which N_{L} is the number of lighting fixtures in the system and Φ is photosynthetic photon flux (PPF) measured in units of μmol/s. The system efficacy ε_{system} may then be calculated as:

ε_{system}=Φ_{system}/P_{system,AC} Equation (8)

in which Φ_{system} is the photometric output of the system and P_{system,AC} is the system's required AC power. The photometric output and efficacy of the system may be provided as outputs to the customer. If the customer is not satisfied with the photometric output or efficacy, the customer may make changes to certain variables (e.g., the type of lighting fixture or power supply used, the dimensions of the grow surface, the mounting height, the average PPFD on the grow surface). The method 900 may be performed again to recalculate the photometric output and efficacy with the updated variables until the customer is satisfied.

In block 1018, the application may also calculate the CapEx and OpEx of the proposed system. The CapEx C_{capex} may be calculated as:

C_{capex}=(N_{PS}C_{PS}+N_{L}C_{L})K Equation (9)

in which N_{PS} is the number of power supplies in the system, C_{PS} is the cost of each power supply, N_{L} is the number of lighting fixtures in the system, C_{L}, is the cost of each lighting fixture, and K is an adjustable multiplier representing costs of ancillary components, such as packaging, labor, overhead, etc. The OpEx Cₒₚₑₓ may be calculated as:

Cₒₚₑₓ=C_{power}P_{system,DC}T_{period}/ηT_{cost} Equation (10)

in which C_{power} is customer's cost for electricity service, P_{system,DC} is the DC wattage of the system, T_{Period} is the lighting period used by the customer in days and is provided by the customer, T_{cost} is the time period for which OpEx cost is being assessed in days and is provided by the customer, and η is the power supply efficiency at the system service voltage.

The application may output the CapEx and OpEx to the customer. If the customer is not satisfied with the CapEx or OpEx costs, the customer may make changes to certain variables (e.g., the type of lighting fixture or power supply used, the dimensions of the grow surface, the mounting height, the average PPFD on the grow surface). The method 1000 may be performed again to recalculate the CapEx and OpEx with the updated variables until the customer is satisfied.

In this way, the method 1000 provides a quick way to determine the optimal modular lighting system configuration for a customer starting from just a few input parameters. It also allows customers to change the parameters on the fly in order to see how the optimal lighting solution changes. This allows a customer to quickly assess their options and settle on a solution using an electronic interface, rather than spend weeks experimenting with various setups and prototypes in their physical grow environment before finding a satisfactory solution. The modularity of the system allows the application to use the same processes and equations to determine the relevant outputs (e.g., system efficacy, CapEx, OpEx). If the system were made from custom parts, then the calculation of the outputs would have to be derived specifically for those parts.

### Sales Process Flow

The development and sale of custom lighting solutions, which often occur with lighting solutions in indoor farming environments, may become a strain on the sales cycle because of the need to certify, approve, and stamp the solution with multiple shareholders involved in the process. The sales process shareholders (e.g., sales team, engineering team, finance team, management) may have varying levels of workload and available time, which can cause the sales process flow to slow down the overall time period from start to finish of delivering a custom lighting solution. Because of this, certain risks to revenue may arise due to the amount of time it takes to develop custom lighting solutions, and also due to limited time and resources on the seller's side to serve multiple clients and potential clients. However, the use of modular horticultural lighting systems to create custom lighting solutions leads to sales process flow improvements that significantly reduce the time to delivery of a custom solution while also reducing risks to the seller's revenue.

Under the old sales process flow for creating custom lighting solutions, a customer may contact a seller about purchasing a lighting solution that satisfies the customer's lighting requirements. The seller may not have any off-the-shelf products that satisfy the lighting requirements. The sales department may make an initial assessment whether a custom solution may be delivered on the customer's timeline, and if not the seller may lose the sale. If a custom solution is feasible, the sales department may initiate an internal custom product request. The finance department may assess whether developing the custom solution has a sufficient return on investment, and if not the sale is lost. If the custom solution is financially feasible, the sales team may present a proposed solution, cost, and delivery timeline to the customer. If the customer is not satisfied and the proposal cannot be negotiated to satisfy the customer, the sale may be lost. If the customer proceeds, the engineering, operations, and/or manufacturing teams begin procuring supplies and validating the custom design specifications. The custom solution is then manufactured and delivered to the customer. This whole process may take an order of 4-6 months from start to finish, and there are multiple points at which the sale may fall through.

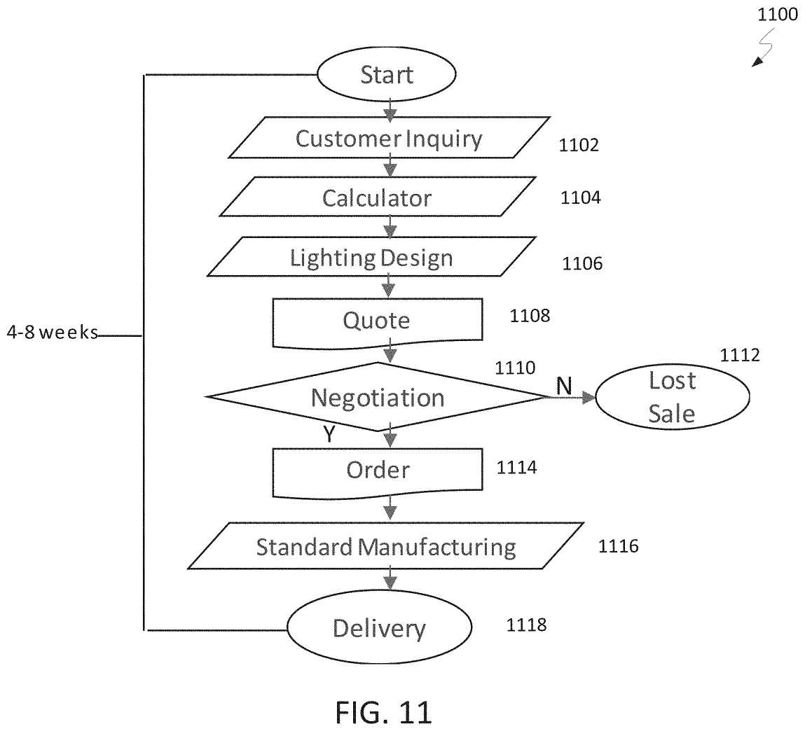

FIG. 11 is a flow chart illustrating a sales process method 1100 for modular horticultural lighting systems in accordance with various implementations. The method 1100 may be performed by one or more employees of the seller of the modular horticultural lighting system. Certain parts of the method 1100 may be automated as well, and may be performed by one or more computing devices.

In block 1102, a customer may contact the seller about purchasing a lighting solution that satisfies the customer's lighting requirements. The seller may not have any off-the-shelf products that satisfy the lighting requirements, and so a custom solution is required.

In block 1104, the seller may determine whether there one or more possible configurations of the modular horticultural lighting system that satisfy the customer's lighting requirements and are economically feasible for the seller to assemble and sell. The lighting solution calculator described in relation to FIG. 10 may be used by the seller to identify possible solutions to the customer's lighting requirements from the modular horticultural lighting system.

In block 1106, a lighting design proposal may be developed from the results of the lighting solution calculator. In block 1108, a quotation of the solution may be generated, which may include the list of components and their configuration, the cost, and the delivery timeline.

In block 1110, the seller may present the quotation to the customer and the parties may negotiate the terms of the quote. It is noted that the quotation may be easily and quickly adjusted because the lighting solution calculator may quickly generate alternate solutions to satisfy customer's requests during negotiation. Thus the negotiation may become a collaborative process in which the seller and customer work together to make small adjustments to the proposed system or test out hypothetical designs. Contrast this with the old sales process flow, in which changes to a proposed custom solution may have to be reviewed and approved by multiple seller stakeholders before being presented to the customer. A seller and customer may resolve negotiations within hours using the lighting solution calculator disclosed herein as opposed to perhaps weeks under the old process.

If negotiations fail and the customer rejects the quotation, the sale is lost in block 1112. If the negotiations succeed and the parties agree on a quotation, the custom solution order is finalized and initiated in block 1114. In block 1116, the custom solution using the components of the modular horticultural lighting system is procured, manufactured, and/or assembled. In block 1118, the completed custom solution is delivered to the customer. The time to complete the method 1100 may be on the order of 4-8 weeks, which is much quicker than the 4-6 month timeline under the old sales process flow. Thus the modular horticultural lighting system disclosed herein may vastly speed up the time it takes to deliver custom solutions to customers that exactly or closely meet the customer's lighting requirements.

### Supply Chain Optimization

The modular horticultural lighting system described herein may also result in efficiencies in supply chain, manufacturing, and fulfillment operations of the manufacturer due to the common architecture and interchangeability of components that make up the system. In other words, because the same customer lighting needs may be satisfied by multiple permutations of components in the system, the components in the system may be adjusted dynamically due to supply chain issues.

For example, the system calculator described herein may determine that the optimal system for a customer's lighting requirements includes 24 low-power emitting surfaces, one 300 W DC power supply, one 6-port manifold, six 4-port harnesses, and ten 4-foot mounting rails. However, if there is a material, manufacturing, or supply constraint that prevents the manufacturer from providing 24 low-power emitting surfaces, they may instead be replaced by mid-power emitting surfaces that receive the same power. Alternatively, if there is no 300 W DC power supply available to ship, a 600 W DC power supply that has been programmed to output only 300 W DC may be shipped instead. The remaining hardware is also interchangeable and subject to the same manufacturing and supply-chain efficiencies. For example, if stock is low, or there is a quality problem with the 4-port harnesses, the system can be reconfigured to include four 6-port harnesses and a 4-port manifold instead. Likewise, instead of ten 4-foot mounting rails, twenty 2-foot mounting rails may be shipped instead.

The performance of the modular horticultural lighting system (e.g., in terms of efficacy, light intensity, and/or uniformity) is unchanged, and it is only the material costs that differ between these solutions. In some cases, replacement of components may result in an increase of cost for the system (e.g., using mid-power emitting surfaces to fulfill an order that only needs low-power emitting surfaces). However, the customer still receives their product on time and the relationship is preserved. The customer also has the choice to balance time (delayed shipment) with cost (increase in price for replaced components).

Due to redundancy of components in the modular horticultural lighting system, sales teams have the flexibility to re-design solutions that deliver the same system performance in cases in which manufacturing or supply-chain is unable to deliver the optimal solution. Since the system is constructed to allow for any mix of the components to be paired to build a complete system, no extra certification or engineering work is required to create new combinations of components that achieve the same system performance. The speed at which an organization can reconfigure a modular horticultural lighting system and deliver it to the customer allows the sales relationship to be preserved and maintained in good-standing, all with very little impact to normal sales and supply operations.

### OTHER CONSIDERATIONS

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, Blu-Ray, magnetic disk, internal hard drive, external hard drive, memory stick, flash drive, solid state memory device, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some implementations, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s), handheld device(s) such as cellular telephone(s) or smartphone(s) or tablet(s), laptop(s), laptop/tablet hybrid(s),handheld computer(s), smart watch(es), or any another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

The foregoing description of the implementations of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

What is claimed is:

1. A lighting system, comprising:
a power supply; and
a lighting fixture coupled to the power supply, the lighting fixture comprising a determined number of removable emitting surfaces;
wherein:
the lighting system satisfies a target photosynthetic photon flux density (PPFD) at a canopy of a plant bed having a specified area and a specified mounting height of the determined number of emitting surfaces above the canopy;
the determined number of emitting surfaces is determined based on at least the target PPFD, the specified area, and the specified mounting height;
a system wattage supplied by the power supply is determined based on at least the determined number, the target PPFD, the specified area, and the specified mounting height; and
a spacing between each of the emitting surfaces is determined based on at least the determined number and the specified mounting height.

2. The lighting system of claim 1, wherein when at least one of the target PPFD, the specified area, and the specified mounting height are changed, the determined system wattage, the determined number, and the spacing between each of the emitting surfaces are re-determined.

3. The lighting system of claim 2, wherein when the re-determined system wattage exceeds a maximum wattage of the power supply, the power supply is replaced by a replacement power supply having a maximum wattage above the re-determined system wattage.

4. The lighting system of claim 2, wherein when the re-determined number of emitting surfaces is greater than the determined number of emitting surfaces, additional removable emitting surfaces are added to the lighting fixture and a spacing between each of the re-determined number of emitting surfaces is adjusted to equal to the re-determined spacing.

4. The lighting system of claim 2, wherein when the re-determined number of emitting surfaces is less than the determined number of emitting surfaces, excess emitting surfaces are removed from the lighting fixture and a spacing between each of the remaining emitting surfaces is adjusted to equal to the re-determined spacing.

5. The lighting system of claim 1, wherein when the determined system wattage is less than a maximum wattage of the power supply, the system further comprises one or more peripheral devices coupled to the power supply.

6. The lighting system of claim 5, wherein the one or more peripheral devices comprise at least one of a fan, a heater, a sensor, a communications module, and a control device.

7. The lighting system of claim 5, wherein the one or more peripheral devices consume a total peripheral wattage, the total peripheral wattage plus the determined system wattage being less than or equal to the maximum wattage of the power supply.

8. The lighting system of claim 1, further comprising a first connector coupling the power supply to the determined number of emitting surfaces.

9. The lighting system of claim 8, wherein when the determined number changes to a re-determined number of emitting surfaces, the first connector is replaced by a second connector that couples the power supply to the re-determined number of emitting surfaces.

10. The lighting system of claim 1, further comprising a plurality of connectors coupling the power supply to the determined number of emitting surfaces.

11. The lighting system of claim 10, wherein when one of the plurality of connectors fails, the failed connector is replaced by an identical replacement connector.

12. The lighting system of claim 1, wherein when at least one of the emitting surfaces fail:
the at least one failed emitting surfaces are removed;
the spacing between the remaining emitting surfaces is adjusted based on the specified area; and
the specified mounting height is adjusted based on the spacing between the remaining emitting surfaces.

13. The lighting system of claim 1, wherein the specified mounting height is equal to the spacing between each of the emitting surfaces.

14. The lighting system of claim 1, wherein:
the power supply is selected from a plurality of power supplies, each of the plurality of power supplies having a maximum wattage; and
the selected power supply has a smallest difference between its maximum wattage and the system wattage.

15. The lighting system of claim 1, wherein different combinations of values of the system wattage, the determined number, the spacing, and the specified mounting height satisfy the target PPFD and the specified area.
